(19) United States
(12) Patent Application Publication
(10) Pub. No.: US 2009/0127401 A1
(43) Pub. Date: May 21, 2009

(54) ION FIELD FLOW CONTROL DEVICE

(76) Inventors: William T. Cousins, Glastonbury, CT (US); Alan B. Minick, Madison, AL (US)

Correspondence Address: CARLSON, GASKEY & OLDS/PRATT & WHITNEY, 400 WEST MAPLE ROAD, SUITE 350, BIRMINGHAM, MI, 48009, US

(21) Appl. No.: 11/936,190

(22) Filed: Nov. 7, 2007

(51) Int. Cl. B64C 21/00; B23K 11/24

(52) U.S. Cl. 244/205; 323/318

(57) ABSTRACT

Disclosed is a boundary layer control apparatus, and method, for controlling and adjusting the boundary layer of a fluid flowing over a surface. The apparatus and method operate by using ionic wind to propel the fluid within the boundary layer in a specified direction thereby either increasing or decreasing the boundary layer thickness.

### BACKGROUND OF THE INVENTION

The present application relates to boundary layer control using ionic winds.

In an aircraft gas turbine engine, such as a turbofan engine, air is pressurized in a compressor, and then mixed with fuel in a combustor for generating hot combustion gasses. The hot combustion gasses flow downstream through several stages of the turbine engine which extract energy from the hot combustion gasses. A fan is used to supply air to the compressor.

A core exhaust nozzle is used to discharge the combustion gasses and a quantity of fan air is discharged through an exhaust nozzle at least partially defined by a nacelle assembly surrounding the core engine. The pressurized fan air which is discharged through the fan nozzle provides the majority of propulsive thrust, while the remainder of the thrust is provided by the core exhaust nozzle.

It is known in the field of aircraft engine design that the performance of a turbofan engine varies during diversified conditions experienced by the aircraft. An inlet lip section located on the foremost end of the turbofan nacelle assembly is typically designed to reduce separation of airflow from the inlet lip section of the nacelle assembly and to enable operation of the engine during these conditions. This separation of the airflow is referred to as boundary layer separation. Inlet lip sections are desirably thick in order to support engine operation during specific flight conditions, such as cross-wind conditions, take-off, landing, and other similar conditions. A disadvantage of the thick lip is that it reduces the efficiency of the system during “normal” cruise conditions of the aircraft. It is known that the maximum diameter of the nacelle assembly may be approximately 10-20% larger than the size that would be required in normal cruise conditions.

In addition to reduced cruise efficiency, boundary layer separation is a common problem associated with thick inlet lip sections. The problem arises when separation occurs across the surface of the inlet lip section. Separation may cause engine stalling, the loss of a capability to generate lift, and further decrease engine efficiency.

Attempts have been made in the art to increase the efficiency by reducing the occurrence of boundary layer separation within the nacelle assembly. Vortex generators have been used in the past to increase the velocity gradient of oncoming airflow near the effective boundary layer of the inlet lip section. Additionally, synthetic jets are known which introduce an airflow pulsation at the boundary layer to reduce the pressure gradient of the oncoming airflow near the boundary separation point.

### SUMMARY OF THE INVENTION

Disclosed is a boundary layer control apparatus for controlling a fluid flow over a surface. The boundary layer control apparatus utilizes a network of at least one emitter and at least one receiver to create an ionic wind. The network of emitters and receivers is associated with an object and the ionic wind created by the network of emitters and receivers propels a fluid along the object. These and other features of the present invention can be best understood from the following specification and drawings, the following of which is a brief description.

### BRIEF DESCRIPTION OF THE DRAWINGS

FIG. 1 shows a simplified emitter/receiver array on a surface.

FIG. 2 shows some typical features of the modified boundary layer.

FIG. 3 shows the effect on the boundary layer for various levels of control being applied to a typical embodiment.

FIG. 4 shows a simplified ionic wind generator.

FIG. 5 shows an embodiment associated with a nacelle wall.

### DETAILED DESCRIPTION OF AN EMBODIMENT

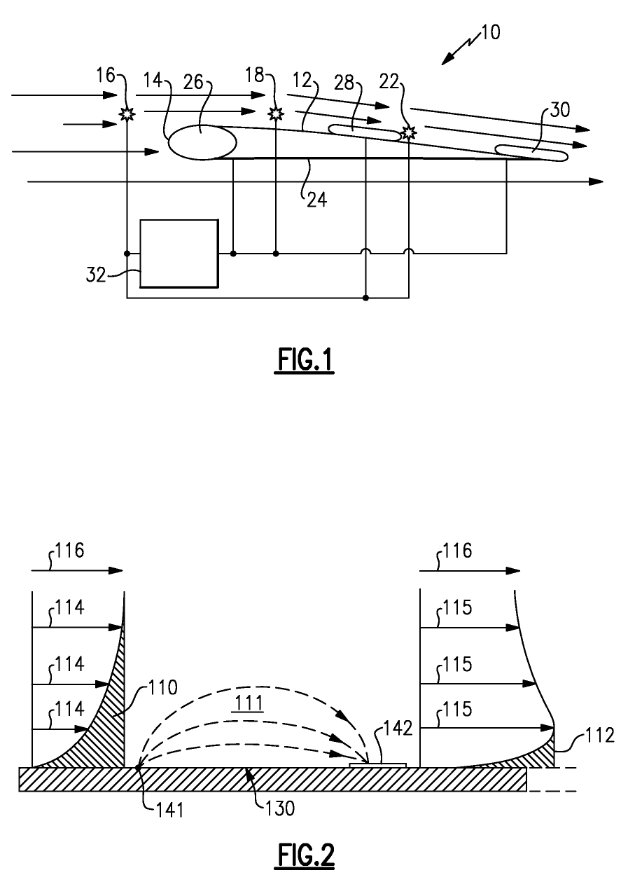

FIG. 1 illustrates a simplified setup for one embodiment of the current application. A first emitter 16 or an emitter/receiver network may be mounted either on a part itself, or on another object ahead of the part. In the case of FIG. 1, the first emitter 16 is shown leading the part on an aircraft. This emitter 16 is coupled with a receiver 26 on or near a leading edge 14 of the part. It is additionally possible to install multiple emitter/receiver pairs, thus allowing for a stronger and larger ionic boundary layer modification to be created. These added emitters 18 and 22 and receivers 28 and 30 may be located in the region of emitters 16 and receivers 26 or elsewhere to provide greater boundary layer control. The leading edge emitters and receivers can be aligned into the inlet and/or along the outer surface of the nacelle.

As shown in FIG. 2, an emitter/receiver network may be utilized to create a directed ion field, referred to as ionic wind 111. The ionic wind 111 is created by running a current through an anode (or cathode) 141 which acts as an emitter, and through a cathode (or anode) 142 which acts as a receiver. The magnitude of the velocity of a fluid traveling in the boundary layer prior to application of the ionic wind 111 is shown represented by the arrows 114 on the left side of FIG. 2. The shaded region 110 represents the loss in velocity of the fluid as it gets closer to the surface 130. Accordingly, the fluid at the top of the shaded region 110 is farther away from the surface 130 than the fluid at the bottom of the shaded region 110. After the ionic wind 111 is applied to the fluid, the altered boundary layer velocity characteristics, which are illustrated in a second shaded region 112, change. The arrows 115 outside the second shaded region 112 illustrates the magnitude of the velocity of the fluid traveling in the boundary layer after the ionic wind 111 has influenced it. In the illustrated example of FIG. 2 the ionic wind 111 is shown forcing the fluid in the direction of the freestream flow 116 above surface 130. This results in a reduced boundary layer thickness as shown in shaded region 112. It is additionally known that the emitter / receiver network could be used to produce an ionic wind 111 which forces a fluid in the opposite direction of the freestream flow 116 above the surface 130 instead of in the same direction. In such a case, the boundary layer (indicated by shaded region 112) after the application of the ion field would instead be thicker than the boundary layer (indicated by shaded region 110) prior to the influence of the ionic wind 111.

Reduction of the boundary layer velocity defect has the effect of decreasing the likelihood of boundary layer separation. Boundary layer separation occurs when the boundary layer lifts off the surface of a part, creating a region of highly turbulent flow containing local reverse flows that lift off the surface. This results in a pressure buildup between the boundary layer and the part. The increase in pressure can result in a decrease in performance characteristics of a part, such as a decreased lift or decreased air intake capabilities, among others.

As illustrated in FIG. 3, it is also possible to selectively vary the thickness of the boundary layer by adjusting the level of control being applied to the emitters 16, 18, and 22 and the receivers 26, 28, and 30. FIG. 3 shows the boundary layer characteristics for a normal flow with no control 123 being applied, for a low level 122 of control being applied, for a higher level 121 of control being applied. Also shown is the boundary layer characteristic with no flow control and near flow separation 124. As can be seen from the shape of the boundary layer characteristics 121, 122, 123, and 124 and the varying levels of control, the higher the level of control applied, the greater the impact on the boundary layer characteristics 121, 122, 123, and 124. Boundary layer characteristics 123 and 124 illustrate the thickness of the boundary layer without the application of any control. The distance from the velocity axis to the curve of the graph is representative of the boundary layer thickness. Boundary layer characteristic 122 illustrates how the thickness is reduced after the application of a minimal boundary layer control. As a larger level of control is applied the thickness decreases, as illustrated with a higher level of control (shown in boundary layer characteristic 121). Varying the level of control is achieved by adjusting the strength of the ionic wind 111. The strength of an ionic wind 111 is determined by the voltage level applied across the emitter/receiver network. FIG. 3 illustrates the boundary layer characteristics 121, 122, 123, and 124 in an embodiment that forces the fluid in the direction of the freestream 116. In an alternative embodiment where the fluid is forced in the opposite direction of the freestream 116 the effect would be reversed and a greater level of control would effect an increase in the boundary layer thickness and a movement towards separation.

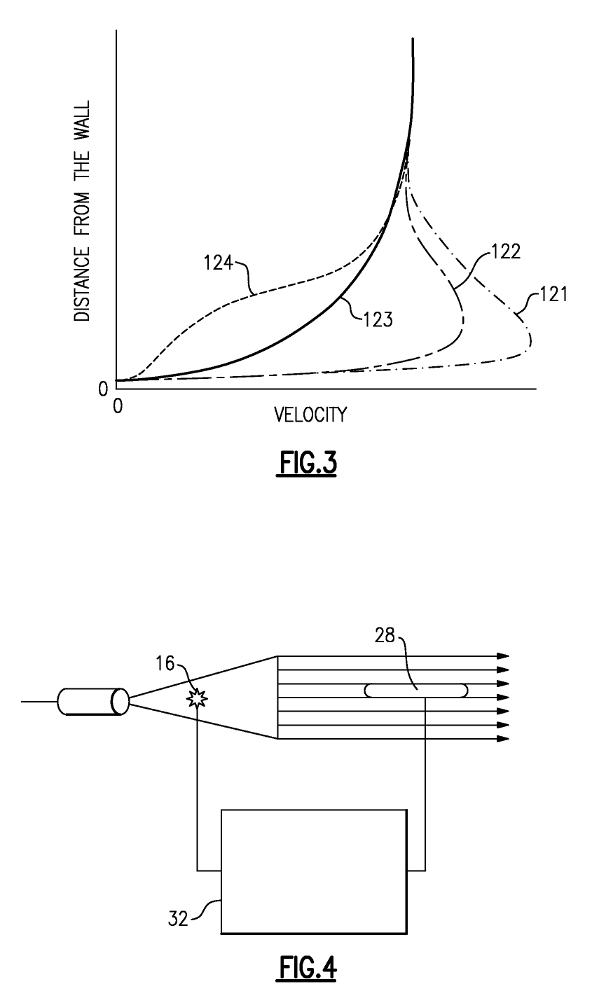

Using emitters 16, 18, and 22 and receivers 26, 28, and 30 to create an ionic wind 111 has the added benefit of needing minimal space to be properly implemented. FIG. 4 illustrates a generic emitter 16 and receiver 28 design capable of creating an ionic wind 111. The emitter 16 and receiver 28 properties of a given component are not defined by their proximity to each other, but by their physical shape. For example, the emitter 16 could be a wire anode and the receiver 26 can be a plate cathode. This allows the emitter 22 and the receiver 28 to be placed immediately adjacent to each other while still retaining the desired ionic wind 111 capabilities.

The emitters 16, 18, and 22 and the receivers 26, 28, and 30 in the illustrated embodiments are powered from a power source 32 capable of producing either pulsed DC power or constant DC power (shown in FIG. 1 and FIG. 4). It is additionally anticipated that an alternating power source could be used to operate the emitter/receiver network.

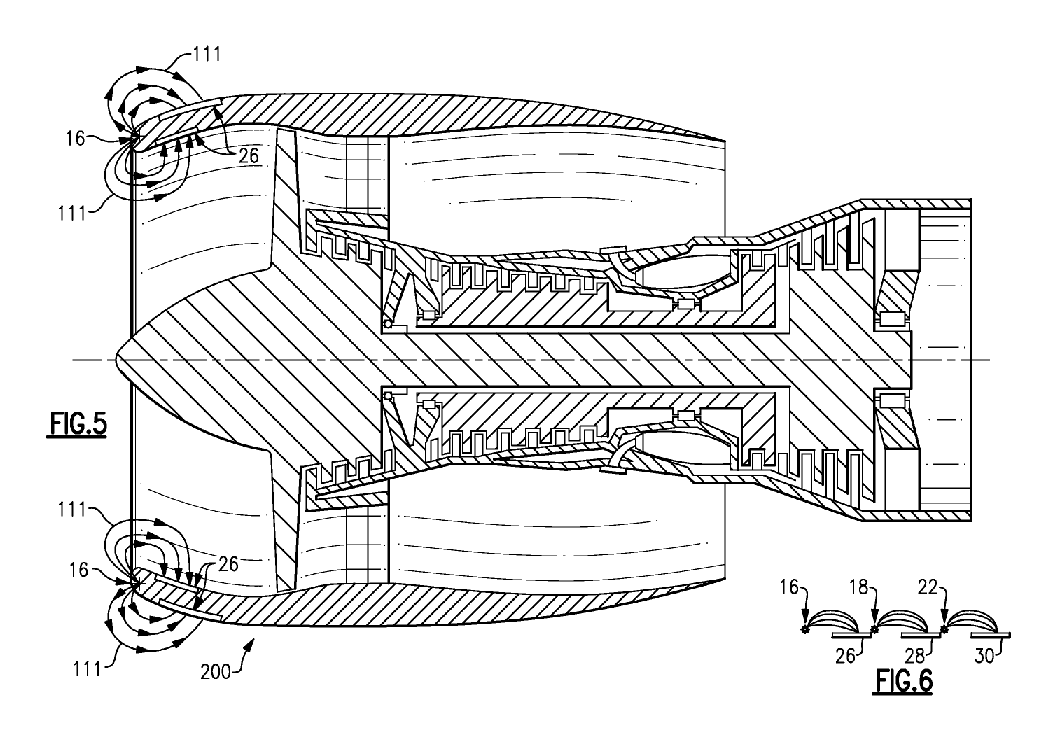

FIG. 5 illustrates emitter 16 and receiver 26 applied to a nacelle 200 of an aircraft. The emitter 16 and receiver 26 are enlarged for illustration purposes and a network consisting of multiple emitter and receiver pairs (such as the network illustrated in FIG. 6) may be utilized in the space occupied by emitter 16 and receiver 26 in FIG. 5. In this embodiment the emitter 16 and the receiver 26 are capable of producing the ionic wind 111 adjacent to the nacelle. The size of ionic wind 111 illustrated in FIG. 5 is exaggerated for illustrative purposes and is not shown to scale. Boundary layer control adjacent to the nacelle 200 of the aircraft can allow for the nacelle to be built with a thinner nacelle wall 210. Typically when constructing a nacelle wall 210 it is necessary to account for non-optimal flight conditions, such as heavy cross winds, by building a thicker nacelle wall 210. Implementing boundary layer control in the nacelle 200, such as is described above, minimizes the impact of adverse conditions and allows for the nacelle leading edge and the wall 210 to be constructed thinner and lighter than is possible without boundary layer control. It is additionally anticipated that implementation of boundary layer control using an embodiment of the disclosed system can improve any system where fluid flows over a surface including other aircraft applications such as serpentine inlets, strut flows, and compressor tip clearance flows, and that the disclosed system would improve or enable boundary layer control in those applications. As indicated in FIG. 1, each set of emitters and attractors may also consist of a series of emitters and attractors providing multiple stages of ion wind enhancement at each given location. Also as indicated in FIG. 1 the charge of the emitters and attractors may be alternated to enhance stage density.

FIG. 6 illustrates a network of emitters 16, 18, and 22 and receivers 26, 28, and 30. The receiver 22 and the emitter 28 have a similar charge allowing them to be placed extremely close together while still retaining the desired ionic wind properties. Likewise, receiver 26 and emitter 18 have similar charges, but different charges than that of emitter 16 and 22 and receiver 28. This configuration of emitters 16, 18, and 22 and receivers 26, 28, and 30 allows a configuration of multiple emitter receiver pairs to placed over a small surface area.

The foregoing description shall be interpreted as illustrative and not in any limiting sense. A worker of ordinary skill in the art would recognize that certain modifications would come within the scope of this invention. For that reason, the following claims should be studied to determine the true scope and content of this invention.

What is claimed is:

1. A boundary layer control apparatus for controlling a fluid flow over a surface, comprising:
at least one emitter and at least one receiver configured to create an ionic wind when voltage is applied; and
said at least one emitter and said at least one receiver associated with an object such that the ionic wind will propel a fluid along said object to control at least one boundary layer characteristic.

2. The boundary layer control apparatus of claim 1 further comprising a controller capable of adjusting a DC power.

3. The controller of claim 2 further comprising said controller being capable of adjusting the DC power at least partially based on at least one desired boundary layer characteristic.

4. The controller of claim 2 further comprising said controller being capable of adjusting the DC power at least partially based on at least one of an aircraft's flight conditions.

5. The boundary layer control apparatus of claim 1, wherein the ionic wind is capable of increasing a boundary layer by propelling the fluid in a same direction as said object's motion when said object is in motion and opposite the direction of a freestream airflow along said object when the object is not in motion.

6. The boundary layer control apparatus of claim 1, wherein the ionic wind is capable of decreasing a boundary layer by propelling the fluid in a direction opposing said object's motion when said object is in motion and in the direction of a freestream airflow along said object when the object is not in motion.

7. A method for controlling a boundary layer using ions comprising:
generating an ionic wind using a network of emitters and receivers; and
said ionic wind propelling an external fluid in a manner that has a desired affect on at least one boundary layer characteristic.

8. The method for controlling a boundary layer of claim 7 additionally comprising controlling the strength of the ionic wind using a controller in order to achieve the desired affect on said at least one boundary layer characteristic.

9. The method of claim 8 wherein the controller is capable of controlling the at least one boundary layer characteristic by adjusting a DC power input level.

10. The method of claim 7 wherein a boundary layer thickness is increased by propelling said external fluid opposite to the direction of a freestream airflow.

11. The method of claim 7 wherein a boundary layer thickness is decreased by propelling said external fluid in the same direction as a freestream airflow.

12. An aircraft component comprising:
a boundary layer control apparatus situated on or within at least one surface of the aircraft component; and
said boundary layer control apparatus utilizing an ionic field to adjust or control a boundary layer.

13. The aircraft component of claim 12 configured to be capable of adjusting at least one boundary layer characteristic.

14. The aircraft component of claim 12 additionally comprising a controller capable of controlling at least one boundary layer characteristic in response to at least one flight condition.

15. The aircraft component of claim 12 wherein the boundary layer control apparatus is situated within at least a nacelle wall.
